(19) United States
(12) Patent Application Publication
(10) Pub. No.: US 2024/0398159 A1
(43) Pub. Date: Dec. 5, 2024

(54) ANTI-STICK TITANIUM COOKWARE

(71) Applicant: TIMAS TITAN CO., LTD., Taipei City (TW)

(72) Inventors: Han-Chun Hsieh, Taipei City (TW); Han-Chieh Hsieh, Taipei City (TW)

(21) Appl. No.: 18/805,505

(22) Filed: Aug. 14, 2024

Related U.S. Application Data
(63) Continuation-in-part of application No. 18/163,237, filed on Feb. 1, 2023.

(30) Foreign Application Priority Data
Feb. 8, 2022 (TW) 111104443

(51) Int. Cl. A47J 36/02

(52) U.S. Cl. CPC A47J 36/025

(57) ABSTRACT

An anti-stick titanium cookware and a method of manufacturing the same are provided. The anti-stick titanium cookware includes a titanium cookware body, a titanium cladding element, a heat-conducting element and an anti-stick layer. The titanium cookware body and the titanium cladding element are made of plate bodies, the titanium cladding element is welded on the lower surface of the titanium cookware body, and an interlayer space is formed between the titanium cladding element and the titanium cookware body. The heat-conducting element is accommodated in the interlayer space and contacts the lower surface of the titanium cookware body. The anti-stick layer is formed on the upper surface of the titanium cookware body. The heat-conducting element is fixed on the lower surface of the titanium cookware body through the titanium cladding element. The anti-stick layer is a titanium oxide film formed on the upper surface of the titanium cookware body.

### CROSS-REFERENCE TO RELATED PATENT APPLICATION

This application is a Continuation-In-Part of the U.S. application Ser. No. 18/163,237, filed on Feb. 1, 2023, and entitled “ANTI-STICK TITANIUM COOKWARE AND METHOD OF MANUFACTURING THE SAME,” now pending. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a titanium cookware, and more particularly to an anti-stick titanium cookware.

### BACKGROUND OF THE DISCLOSURE

Modern people pursue health, so the pots and utensils used to prepare food or the tableware for holding food are required to be non-toxic and zero-pollution. Due to the characteristics of light weight, high temperature resistance, corrosion resistance and low heat conduction of titanium metal, more and more pots and pans are gradually made of titanium metal.

The physical characteristics of titanium metal are light weight and high strength, so titanium metal pans have the advantage of light weight. However, although the thermal conductivity of titanium metal is close to that of steel, titanium metal has the characteristics of fast heat dissipation due to its low specific heat capacity. In addition, titanium metal tableware is mostly made of titanium metal sheets, so titanium metal cannot store heat, and the temperature of the part of the titanium metal pan that contacts the heating source is extremely easy to rise, but the part of the titanium pan that is not in contact with the heating source is easy to cool down quickly. Therefore, the heat energy is concentrated on the part of the titanium metal pan contacting the heat source, and the heat of the titanium metal pan not in contact with the heat source is insufficient. As a result, the ingredients that come into contact with the heat-concentrated position of the titanium metal pan are easily overheated and burnt, while the ingredients that are in contact with the low-temperature position of the titanium metal pan are likely to be undercooked, or even unable to be cooked.

In the related art, a part of the titanium metal pan is combined with a heat-conducting metal layer by using a titanium metal pan, and the heat conduction through the heat-conducting metal layer makes the heating of the titanium metal pan even. However, due to the metallic nature of titanium, intermetallic compounds that will form brittle phases at the interface when titanium is connected with other types of metals, and titanium is prone to welding stress, so the weld is prone to cracks or even breakage, and titanium metal cannot be welded with dissimilar metals. Therefore, in order to provide a heat-conducting layer on the titanium pan, only riveting or other non-welding means can be used to combine the heat-conducting metal layer and the titanium pan.

However, due to the different thermal expansion coefficients of the heat-conducting metal layer and titanium metal, the heat-conducting metal layer and the titanium metal pan will deform in different magnitudes due to stress under long-term use. As a result, gaps are formed on the joint surface of the heat-conducting metal layer and the titanium metal pot to form uneven contact, so the thermal conductivity is reduced, and the temperature distribution of the pot is also uneven.

In addition, the surface of titanium metal will be oxidized to form an oxide film when placed in air. However, the thickness of the oxide film naturally generated by titanium metal is usually only a few angstroms (Å), and the crystallization form is a polycrystalline titanium oxide layer, so the surface of titanium metal is matte and easy to stick. Therefore, when using a titanium metal pan to cook food in a frying manner, sticking will easily occur.

In order to overcome the sticking problem of titanium pots, some products on the market will additionally install an anti-sticking coating on the surface of the titanium pot. However, the coating will be easily peeled off, and the risk that the coating material will peel off and be eaten by the user along with the food is increased.

Due to the above factors, the existing titanium pans are quite inconvenient to use and difficult to manufacture. Therefore, how to overcome the above-mentioned defects through the improvement of structural design has become one of the important issues to be solved.

### SUMMARY OF THE DISCLOSURE

In response to the above-referenced technical inadequacy, the present disclosure provides an anti-stick titanium cookware.

In order to solve the above-mentioned problems, one of the technical aspects adopted by the present disclosure is to provide an anti-stick titanium cookware, which includes a titanium cookware body, a titanium cladding element, a heat-conducting element and an anti-stick layer. The titanium cookware body is made of a titanium plate body. The titanium cookware body has an upper surface and a lower surface opposite to each other, and an accommodating space has a concave shape formed from the upper surface. The titanium cladding element is disposed on the lower surface of the titanium cookware body. The titanium cladding element is made of a titanium plate body, the titanium cladding element has a central portion, and an outer surrounding portion surrounding an outer peripheral edge of the central portion. A flange portion is formed by bending the outer peripheral edge of the central portion, so that a height difference is formed between an outer peripheral edge of the outer surrounding portion and the outer peripheral edge of the central portion. The outer peripheral edge of the outer surrounding portion is welded to the lower surface of the titanium cookware body, so that a distance is maintained between the central portion and the lower surface of the titanium cookware body to form an interlayer space between the lower surface of the titanium cookware body and the titanium cladding element. The heat-conducting element is accommodated in the interlayer space, the heat-conducting element is fixed to the lower surface of the titanium cookware body through the titanium cladding element, and a top surface of the heat-conducting element is in contact with the lower surface of the titanium cookware body. The anti-stick layer is formed on the upper surface of the titanium cookware body. The anti-stick layer is a titanium oxide film formed on the upper surface of the titanium cookware body.

One of the beneficial effects of the present disclosure is that the present disclosure manufactures the titanium cookware body and the titanium cladding element by using a titanium plate body, the titanium cladding element is welded to the lower surface of the titanium cookware body, an interlayer space is formed between the titanium cladding element and the lower surface of the titanium cookware body, the profile shape of the heat-conducting element is configured to be able to be accommodated in the interlayer space, the heat-conducting element is fixed to the lower surface of the titanium cookware body through the titanium cladding element, and the top surface of the heat-conducting element contacts the lower surface of the titanium cookware body, so that the present disclosure can provide an anti-stick titanium cookware having a good thermal conductivity, a uniform temperature distribution and a non-stick surface.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic assembled side view of the first embodiment of the present disclosure;

FIG. 2 is a schematic enlarged cross-sectional view of part II of FIG. 1;

FIG. 3 is an exploded perspective view of the first embodiment of the present disclosure;

FIG. 4 is a flowchart of the steps of the manufacturing method of the first embodiment of the present disclosure;

FIG. 5 is a schematic view of the operation method of the anti-stick layer forming step in the present disclosure;

FIG. 6 is a schematic enlarged cross-sectional view of the second embodiment of the present disclosure;

FIG. 7 is a schematic enlarged cross-sectional view of the third embodiment of the present disclosure;

FIG. 8 is a schematic assembled side view of the fourth embodiment of the present disclosure;

FIG. 9 is a schematic assembled side view of the fifth embodiment of the present disclosure;

FIG. 10 is a schematic assembled side view of the sixth embodiment of the present disclosure;

FIG. 11 is a schematic view showing a method for producing an anti-stick titanium cookware according to the sixth embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

### First Embodiment

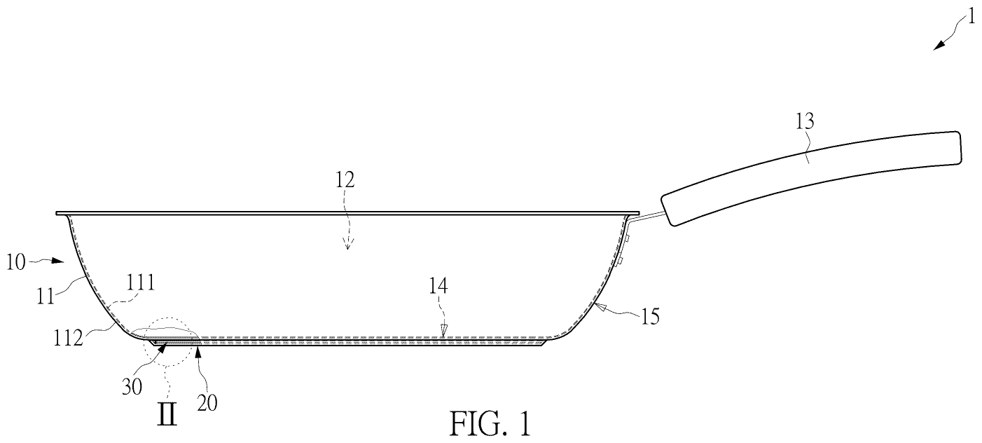

Referring to FIG. 1 to FIG. 5, a first embodiment of the present disclosure provides an anti-stick titanium cookware (such as pot or pan, or pots and pans) and a manufacturing method thereof. For the sake of explanation, this specification will first introduce the structure of the anti-stick titanium cookware 1, and then introduce the manufacturing method of the anti-stick titanium cookware 1.

As shown in FIGS. 1 to 3, the anti-stick titanium cookware 1 of the present disclosure includes a titanium cookware body 10, a titanium cladding element 20 (such as a covering element, or a coating element), a heat-conducting element 30, and an anti-stick layer 40 (or an anti-adhesion layer) formed on the surface of the titanium cookware body 10. In addition, the titanium cookware body 10 is made of a titanium plate body 11, the titanium cookware body 10 has an upper surface 111 and a lower surface 112 opposite to each other, and an accommodating space 12 shaped as a concave shape is formed on, above or from the upper surface 111. In this embodiment, the thickness of the titanium plate body 11 is between 0.3 mm and 3 mm.

The titanium cookware body 10 has a bottom portion 14, and a side portion 15 connected to the outer periphery of the bottom portion 14, the side portion 15 is bent toward (relative to) the upper surface 111, so that the side portion 15 can be connected to the bottom portion 14 to form the accommodating space 12. More particularly, the heat-conducting element 30 contacts the lower surface 112 on the bottom portion 14 of the titanium cookware body 10, and the area of the heat-conducting element 30 is not less than 30% of the area of the bottom portion 14 of the titanium cookware body 10. In this embodiment, the titanium cookware body 10 is a pan, so that the bottom portion 14 is flat, and a handle 13 can be provided and disposed on one side portion of the titanium cookware body 10 to facilitate the user to hold it. However, the present disclosure is not limited thereto. For example, the bottom portion 14 of the titanium cookware body 10 may be in a concave arc shape or other curved surface shapes, and the cross-sectional shape of the side portion 15 may also be a wavy shape, a line shape, or other shape.

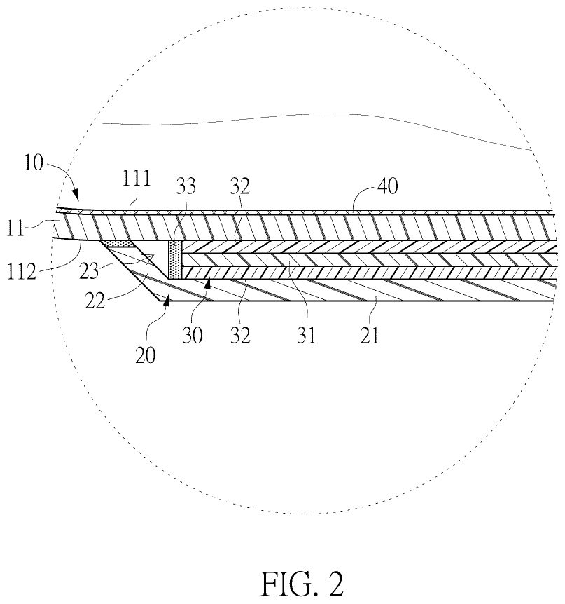

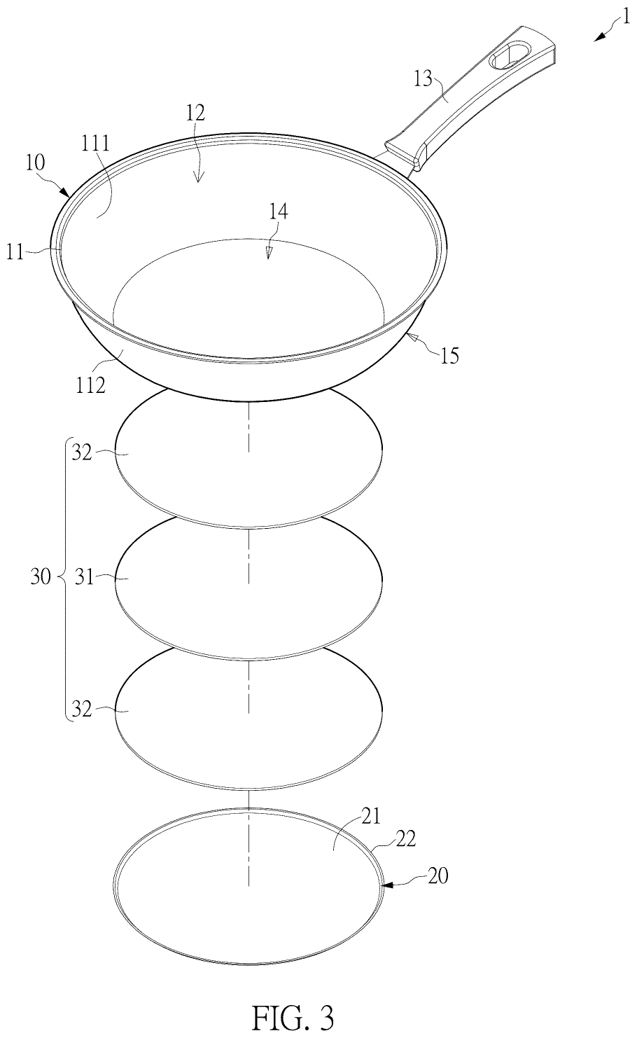

The titanium cladding element 20 is disposed on the lower surface 112 of the bottom portion 14 of the titanium cookware body 10. The titanium cladding element 20 is also made of a titanium plate body. The titanium cladding element 20 has a central portion 21 and an outer surrounding portion 22 surrounding the outer periphery of the central portion 21. As shown in FIG. 2 and FIG. 3, the central portion 21 can be a planar plate or a curved plate that is shaped to fit the bottom portion 14 of the titanium cookware body 10, and the outer surrounding portion 22 is a flange portion bent from the outer peripheral edge of the central portion 21.

The titanium cladding element 20 is welded to the lower surface of the bottom portion 14 of the titanium cookware body 10 by welding the outer peripheral edge of the outer surrounding portion 22 to the lower surface of the bottom portion 14 of the titanium cookware body 10, so that the titanium cladding element 20 is fixed on the lower surface of the titanium cookware body 10. As shown in FIG. 2, there is a height difference between the outer peripheral edge of the outer surrounding portion 22 and the outer peripheral edge of the central portion 21, and the central portion 21 is separate from the lower surface of the bottom portion 14 by a predetermined distance, so that an interlayer space 23 (or a mezzanine space, or a sandwich space) can be formed. After the titanium cladding element 20 is welded, the outer peripheral edge of the outer surrounding portion 22 and the lower surface 112 of the titanium cookware body 10 are completely sealed, so that the interlayer space 23 is formed as an airtight space (or a sealed space, or an enclosed space).

In more detail, the titanium cladding element 20 of the present disclosure can be welded together by means of high-frequency welding, and in order to improve the welding quality, the titanium cladding part 20 is made of a titanium plate body made of the same material as the titanium plate body 11, so that the welding temperature of the titanium cladding element 20 and the titanium cookware body 10 can be consistent so as to avoid welding defects.

The heat-conducting element 30 is received in the interlayer space 23, and the heat-conducting element 30 is disposed on the lower surface 112 of the titanium cookware body 10 through the titanium cladding element 20. The heat-conducting element 30 is a plate with a uniform thickness, and the contour shape of the heat-conducting element 30 in the direction of the orthographic projection of the titanium cookware body 10 matches with or corresponds to the contour shape of the central portion 21 of the titanium cladding element 20, so that the contour shape of the heat-conducting element 30 can match with or correspond to the contour shape of the interlayer space 23 on the bottom portion surface of the titanium cookware body 10, and the thickness of the heat-conducting element 30 can match the height of the interlayer space 23. In addition, the heat-conducting element 30 has a curvature matching with the lower surface 112 of the bottom portion 14 of the titanium cookware body 10 and the central portion 21 of the titanium cladding element 20, so that the heat-conducting element 30 can be accommodated in the interlayer space 23, and the top surface of the heat-conducting element 30 is in contact with the lower surface 112 of the titanium cookware body 10.

The heat-conducting element 30 has at least one the heat-conducting material layer 31, and the heat-conducting material layer 31 can be made of a material with a thermal conductivity higher than 100 W/m·K. For example, the heat-conducting material layer 31 can be made of a metal (such as a copper plate or an aluminum plate) with good thermal conductivity. However, the heat-conducting material layer 31 of the present disclosure is not limited to be made of a thermal conductive metal, and in other feasible embodiments of the present disclosure, the heat-conducting material layer 31 can be made of non-metallic materials or composite materials with good thermal conductivity. For example, the heat-conducting material layer 31 can be made of graphite, or high thermal conductive ceramic materials such as alumina, zirconia, silicon carbide, and boron nitride.

In this embodiment, the heat-conducting element 30 further includes two supporting material layers 32, the supporting material layers 32 are boards each having the same profile shape as the heat-conducting material layer 31, and the supporting material layers 32 are attached to the two opposite sides of the heat-conducting material layer 31. The two supporting material layers 32 can be made of iron, steel, or stainless steel plates, and an annular side portion 33 continuously surrounds the two outer peripheral edges of the two supporting material layers 32 through welding means, so that the two outer peripheral edges of the two supporting material layers 32 are connected together, and the heat-conducting material layer 31 is sealed between the two supporting material layers 32.

In particular, in this embodiment, since the heat-conducting material layer 31 of the heat-conducting element 30 is sealed between the two supporting material layers 32 and the annular side portion 33, when the heat-conducting material layer 31 is made of low-melting-point metals such as copper or aluminum, and when the temperature of the heat-conducting material layer 31 exceeds the melting point during the welding process of the titanium cookware body 10 and the titanium cladding element 20, the flow of the heat-conducting material layer 31 can be restricted through the two supporting material layers 32 and the annular side portion 33, so that the heat-conducting element 30 can maintain the shape of the plate body. In addition, since the supporting material layer 32 has magnetic permeability, it can induce eddy current with the magnetic field of the induction cooker, so that the anti-stick titanium cookware 1 can be used on the induction cooker.

As shown in FIG. 2, the anti-stick layer 40 is at least formed on the upper surface of the titanium cookware body 10 of the present disclosure. The anti-stick layer 40 is a titanium oxide film formed on the upper surface 111 of the titanium cookware body 10 through thermal oxidation, and the anti-stick layer 40 is a titanium oxide film with a thickness greater than 3 micrometers (μm). More specifically, by means of thermal oxidation or plasma oxidation, the surface of the titanium cookware body 10 is in contact with oxygen atoms, nitrogen atoms or other working gas atoms, and the titanium atoms react with oxygen atoms or nitrogen atoms, whereby the anti-stick layer 40 can be formed on the surface of the titanium cookware body 10. The anti-stick layer 40 can be titanium oxides such as titanium oxide (TiOx), titanium nitride (TiN), or titanium oxynitride (TiNxOy).

In particular, in a preferred embodiment of the present disclosure, the titanium plate body 11 of the titanium cookware body 10 is oxidized in the state of a phase, so that the titanium atoms and oxygen atoms or nitrogen atoms on the surface of the titanium plate body 11 can react to form a titanium oxide film with a rutile crystal form. Since the titanium oxide film in the rutile crystal form has the characteristics of dense texture, high hardness, and non-toxicity, the upper surface 111 of the titanium cookware body 10 is changed or modified from the original metal surface to a ceramic titanium oxide film surface, thus forming an anti-stick surface, the surface hardness of the upper surface 111 of the titanium cookware body 10 is improved so that it is not easy to wear, and is not easy to be oxidized and corroded, and will not release toxicity. In addition, since the titanium oxide film can be closely bonded to the titanium atoms on the surface of the titanium cookware body 10, the anti-stick layer 40 is not easy to peel off, and can be used for a long time without damage.

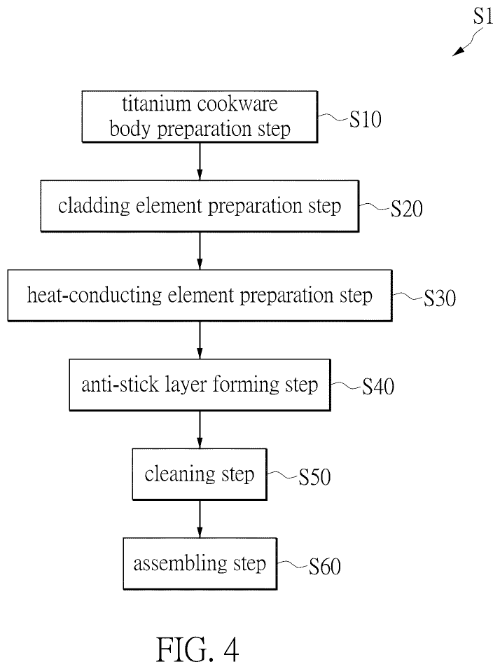

The following introduces the manufacturing method of the anti-stick titanium cookware 1 of the present disclosure. As shown in FIG. 4, the manufacturing method S1 of the present disclosure includes: a titanium cookware body preparation step S10, a cladding element preparation step S20, a heat-conducting element preparation step S30, an anti-stick layer forming step S40, a cleaning step S50, and an assembling step S60.

The titanium cookware body preparation step S10 is to use the titanium plate body to manufacture the titanium cookware body 10. The step S10 of preparing the titanium cookware body can form a planar titanium plate body into the titanium cookware body 10 through different means such as stamping, rolling, forging and the like. The formed titanium cookware body 10 has an upper surface 111 and a lower surface 112 opposite to each other, and the upper surface 111 of the titanium cookware body 10 forms an accommodating space 12.

The cladding element preparation step S20 is to use the same titanium plate body as the titanium cookware body 10 to manufacture the titanium cladding element 20, and the titanium cladding element 20 has a central portion 21, and an outer surrounding portion 22 bent from the outer peripheral edge of the central portion 21. In addition, the height difference between the outer surrounding portion 22 and the central portion 21 is configured to match the thickness of the heat-conducting element 30.

The heat-conducting element preparation step S30 is to use at least one heat-conducting material layer 31 to manufacture the plate-shaped heat-conducting element 30, the heat-conducting element 30 can be placed in the interlayer space 23 between the titanium cladding element 20 and the lower surface of the titanium cookware body 10, and the top surface of the heat-conducting element 30 can be in contact with the lower surface of the titanium cookware body 10.

In the present embodiment, the step S30 of preparing the heat-conducting element includes: using a heat-conducting material to make the heat-conducting material layer 31, using iron, steel, or stainless steel plates to manufacture two supporting material layers 32, assembling the two supporting material layers 32 on the two opposite sides of the heat-conducting material layer 31, and then forming an annular side portion 33 on the outer peripheral edges of the two supporting material layers 32 by means of welding so as to surround the outer peripheral edges of the two supporting material layers 32 at 360 degrees, so that the heat-conducting material layer 31 is sealed between the two supporting material layers 32 to form the heat-conducting element 30.

The anti-stick layer forming step S40 is to form the anti-stick layer 40 by means of thermal oxidation or plasma oxidation on the titanium cookware body 10. The anti-stick layer 40 is a titanium oxide film with a thickness greater than 3 microns (μm). Through the above-mentioned method, the anti-stick layer 40 can form a titanium oxide layer in the rutile crystal form. In the present disclosure, through higher oxidation temperature and longer time, the anti-stick layer 40 formed on the surface of the titanium cookware body 10 has a larger thickness and a denser crystal structure.

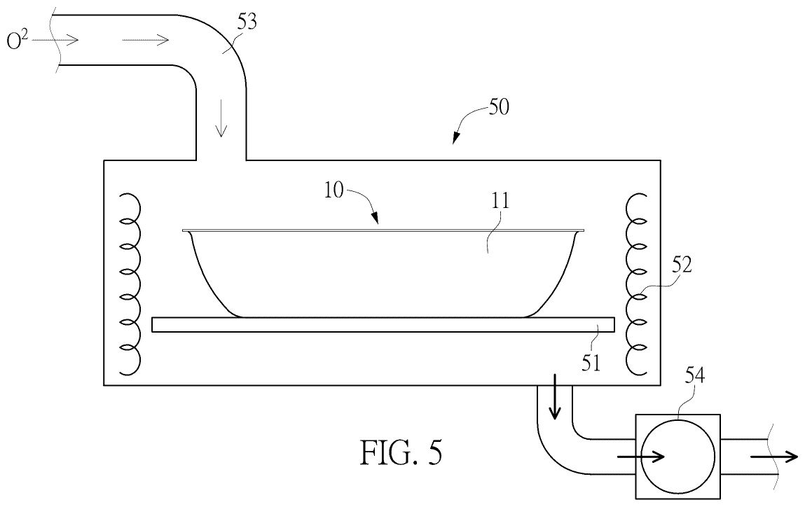

Referring to FIG. 5, which is a schematic view of a method for forming the anti-stick layer 40 by means of thermal oxidation according to the present disclosure. In this embodiment, thermal oxidation is performed through a heating furnace. The heating furnace can be a vacuum calciner 50. The vacuum calciner 50 has a support frame 51 for carrying the titanium cookware body 10, a heating device 52, a vacuuming device 54, and an air inlet pipe 53 connected to the vacuum calciner 50. In the anti-stick layer forming step S40, the titanium cookware body 10 that has been welded with the titanium cladding element 20 is placed on the support frame 51 of the vacuum calciner 50, and then the titanium cookware body 10 is heated in a state where a vacuum environment is formed in the vacuum calciner 50 through the vacuuming device 54, so that the titanium cookware body 10 is annealed. Then be heated to a predetermined oxidation temperature, and then air, or oxygen, or nitrogen, or nitrogen-oxygen mixed gas is introduced into the vacuum calciner 50 through the air inlet pipe 53, so that the surface of the titanium cookware body 10 is oxidized to form the anti-stick layer 40.

The cleaning step S50 is to remove the grease and pollutants on the surface of the titanium cookware body 10 and the titanium cladding element 20 through pickling, sandblasting and other means.

The assembling step S60 is to place the heat-conducting element 30 between the titanium cladding element 20 and the titanium cookware body 10, and the outer surrounding portion 22 of the titanium cladding element 20 is welded to the lower surface 112 of the titanium cookware body 10 by means of welding. In particular, in the assembling step S60 of the present disclosure, the titanium cladding element 20 and the titanium cookware body 10 can be welded by means of high-frequency welding.

After the assembling step S60 is completed, the titanium cladding element 20 is welded to the lower surface of the titanium cookware body 10, and the outer peripheral edge of the outer surrounding portion 22 can be in close contact with the lower side of the titanium cookware body 10. The interlayer space 23 is formed between the titanium cladding element 20 and the lower side 112 of the titanium cookware body 10, and the heat-conducting element 30 is accommodated in the interlayer space 23.

It is worth noting that the anti-stick titanium cookware 1 disclosed in the embodiment of the present disclosure can be not only a pot for cooking dishes or soup, but also a teapot or kettle for boiling water.

### Second Embodiment

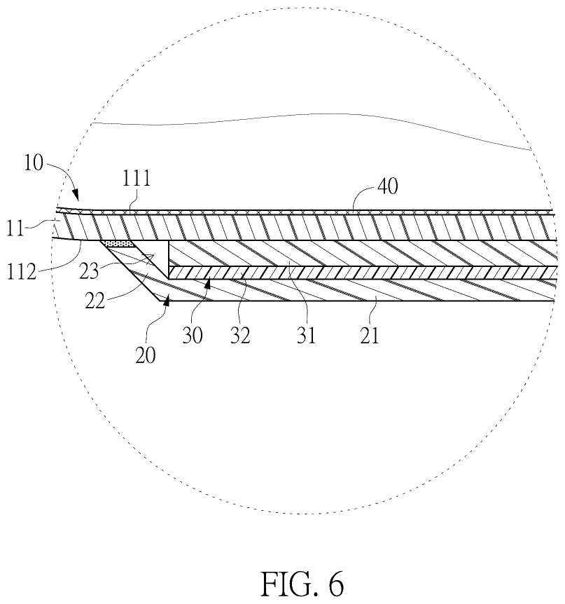

As shown in FIG. 6, which is a second embodiment of the anti-stick titanium cookware 1 of the present disclosure. It should be noted that this embodiment is similar to the above-mentioned first embodiment, so that the similarities between the two embodiments will not be repeated. As shown in FIG. 6, in this embodiment, the heat-conducting element 30 is composed of a heat-conducting material layer 31 and a supporting material layer 32, the supporting material layer 32 can be iron, steel, or stainless steel plate body, and the heat-conducting material layer 31 is disposed on one side portion of the supporting material layer 32.

### Third Embodiment

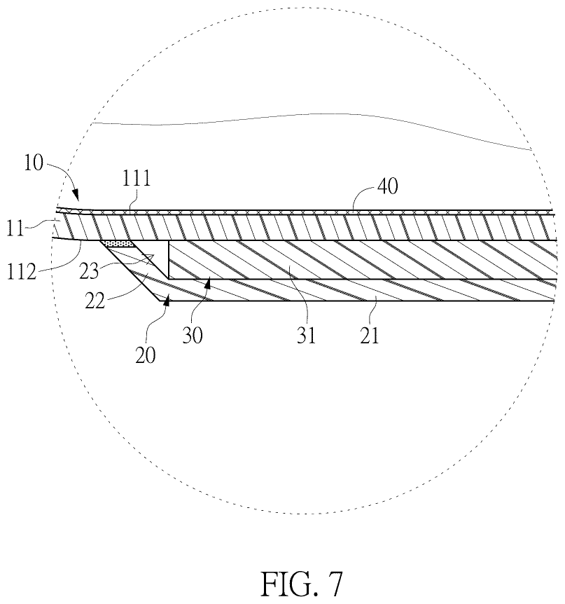

As shown in FIG. 7, which is a third embodiment of the anti-stick titanium cookware 1 of the present disclosure. It should be noted that this embodiment is similar to the above-mentioned first embodiment, so that the similarities between the two embodiments will not be repeated. As shown in FIG. 7, in this embodiment, the heat-conducting element 30 is composed of a plate-shaped heat-conducting material layer 31, and the heat-conducting material layer 31 has a shape and a thickness that match with the interlayer space 23 so as to be accommodated in the interlayer space 23.

### Fourth Embodiment

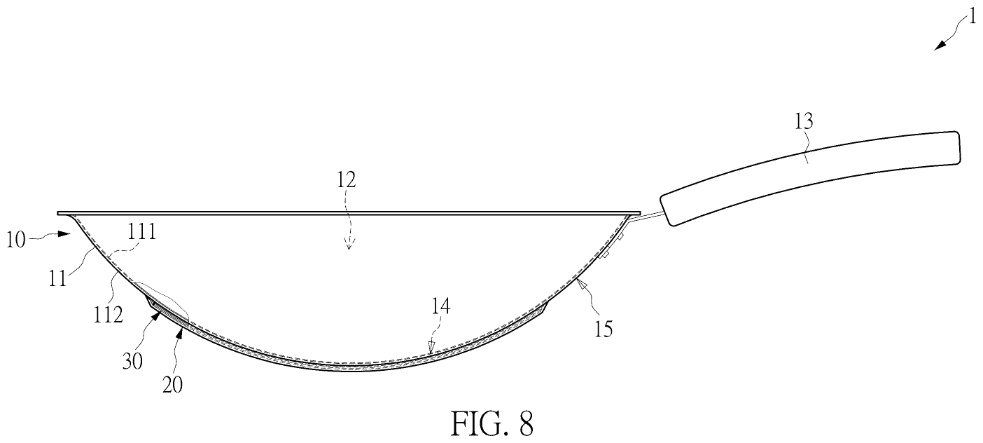

As shown in FIG. 8, which is a fourth embodiment of the anti-stick titanium cookware 1 of the present disclosure. It should be noted that this embodiment is similar to the above-mentioned first embodiment, so that the similarities between the two embodiments will not be repeated. As shown in FIG. 8, in this embodiment, the titanium cookware body 10 forms a wok structure with a circular bottom portion, so that the titanium cookware body 10 has a circular arc-shaped bottom portion 14, and a side portion 15 connected to the outer side of the bottom portion 14. Therefore, the heat-conducting element 30 and the titanium cladding element 20 are also made to have a curved plate body structure that matches the lower surface of the titanium cookware body 10, so that the heat-conducting element 30 can be fixed on the lower surface of the titanium cookware body 10 through the metal cladding element 20, and the top surface of the heat-conducting element 30 can contact with the lower surface 112 of the titanium cookware body 10.

### Fifth Embodiment

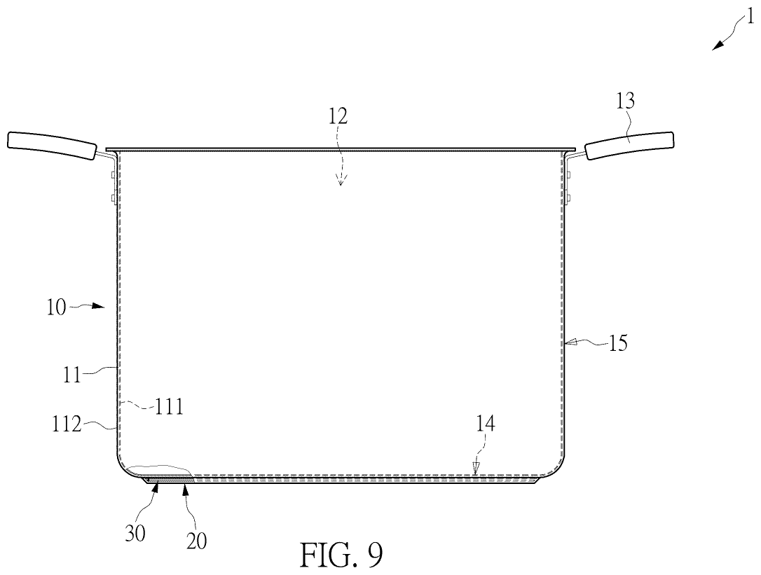

As shown in FIG. 9, which is a fifth embodiment of the anti-stick titanium cookware 1 of the present disclosure. It should be noted that this embodiment is similar to the first embodiment above, so that the similarities between the two embodiments will not be repeated here. As shown in FIG. 9, in this embodiment, the titanium cookware body 10 forms a soup pot structure having a planar bottom portion 14. Therefore, the heat-conducting element 30 and the titanium cladding element 20 are also made to have a planar structure that matches the lower surface of the bottom portion 14, so that the heat-conducting element 30 can be fixed on the lower surface of the titanium cookware body 10 through the metal cladding element 20, and the top surface of the heat-conducting element 30 can contact with the lower surface 112 of the titanium cookware body 10.

### Fifth Embodiment

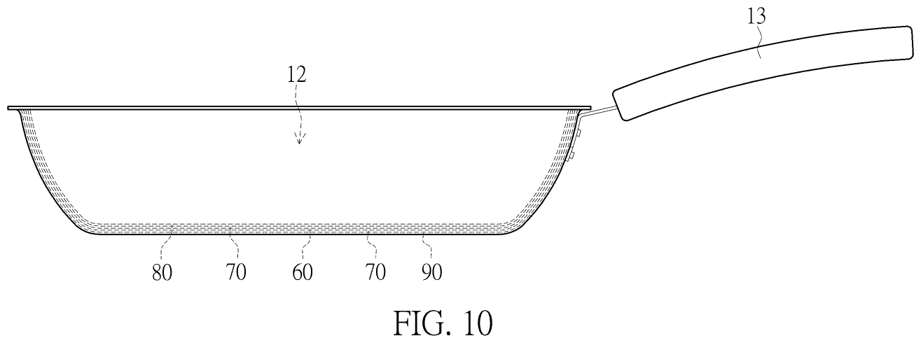

As shown in FIG. 10, FIG. 10 is a schematic assembled side view of the sixth embodiment of the present disclosure. The present embodiment provides an anti-stick titanium cookware 1. Specifically, the anti-stick titanium cookware 1 can include a first aluminum alloy layer 60, two second aluminum alloy layers 70, a titanium layer 80, and a stainless steel layer 90.

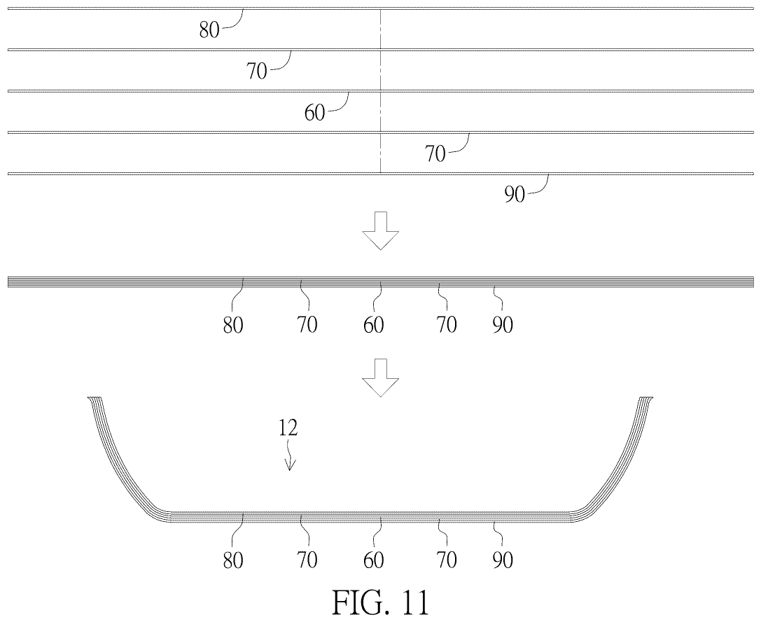

Referring to FIG. 11, FIG. 11 is a schematic view showing a method for producing an anti-stick titanium cookware according to the sixth embodiment of the present disclosure. The first aluminum alloy layer 60, the two second aluminum alloy layers 70, the titanium layer 80, and the stainless steel layer 90 can be adhered to each other in a heavily pressing manner, and then the first aluminum alloy layer 60, the two second aluminum alloy layers 70, the titanium layer 80, and the stainless steel layer 90 can be formed into the anti-stick titanium cookware 1 through a mold (not shown), such that the anti-stick titanium cookware 1 can be in a five-layered structure. The titanium layer 60 can be made of pure titanium, but the present disclosure is not limited thereto.

The two second aluminum alloy layers 70 are disposed at two opposite sides of the first aluminum alloy layer 60. The titanium layer 80 is disposed at one side of one of the second aluminum alloy layers 70 away from the first aluminum alloy layer 60, and the a stainless steel layer 90 is disposed at one side of another one of the second aluminum alloy layers 70 away from the first aluminum alloy layer 60. The anti-stick titanium cookware 1 bends from stainless layer 90 to the titanium layer 80 to form an accommodating space 12 in a concave shape. The titanium layer 80 can provide an anti-stick effect, and the stainless steel layer 90 can provide a magnetic permeability effect.

A tensile strength of the first aluminum alloy layer 60 is greater than a tensile strength of each of the second aluminum alloy layers 70, such that the two second aluminum alloy layers 70 can be easily adhered to the titanium layer 80 and the stainless steel layer 90. Preferably, the tensile strength of the first aluminum alloy layer 60 is between 110 Mpa and 120 Mpa, and the tensile strength of each of the second aluminum alloy layers 70 is between 70 Mpa and 80 Mpa.

Based on 100 parts by weight of the first aluminum alloy layer 60, the first aluminum alloy layer 60 includes 1 part by weight to 1.5 part by weight of manganese (Mn), 0.05 parts by weight to 0.2 parts by weight of copper (Cu), 0.5 parts by weight to 0.9 parts by weight of iron (Fe), 0.4 parts by weight to 0.8 parts by weight of silicon (Si), 0.05 parts by weight to 0.15 parts by weight of zinc (Zn), and a remaining amount of aluminum (Al). The material of the first aluminum alloy layer 60 can be 3003 aluminum alloy, but the present disclosure is not limited thereto.

Based on 100 parts by weight of each of the second aluminum alloy layers 70, each of the second aluminum alloy layers 70 includes 0.01 parts by weight to 0.25 parts by weight of silicon (Si), 0.01 parts by weight to 0.05 parts by weight of copper (Cu), 0.01 parts by weight to 0.05 parts by weight of magnesium (Mg), 0.01 parts by weight to 0.05 parts by weight of zinc (Zn), 0.01 parts by weight to 0.05 parts by weight of manganese (Mn), 0.01 parts by weight to 0.03 parts by weight of titanium (Ti), 0.01 parts by weight to 0.05 parts by weight of vanadium (V), 0.01 parts by weight to 0.4 parts by weight of iron (Fe), and a remaining amount of aluminum (Al). A material of each of the second aluminum alloy layers 70 can be 1050 aluminum alloy, but the present disclosure is not limited thereto.

Based on 100 parts by weight of the stainless steel layer 90, the stainless steel layer 90 includes 0.01 parts by weight to 0.12 parts by weight of carbon (C), 0.01 parts by weight to 1 part by weight of manganese (Mn), 0.01 parts by weight to 0.04 parts by weight of phosphorus (P), 0.01 parts by weight to 0.03 parts by weight of sulfur(S), 0.01 parts by weight to 1 part by weight of silicon (Si), 16 parts by weight to 18 parts by weight of chromium (Cr), and a remaining amount of iron. A material of the stainless steel layer 90 can be 430 stainless steel, but the present disclosure is not limited thereto.

A thickness of the first aluminum alloy layer 60 is between 0.5 mm and 0.7 mm, and a thickness of each of the second aluminum alloy layers 70 is between 0.5 mm and 0.7 mm. A thickness of the titanium layer 80 is between 0.4 mm and 0.5 mm, and a thickness of the stainless layer 90 is between 0.4 mm and 0.5 mm.

### Beneficial Effects of the Embodiments

One of the beneficial effects of the present disclosure is that the present disclosure manufactures the titanium cookware body and the titanium cladding element by using a titanium plate body, the titanium cladding element is welded to the lower surface of the titanium cookware body, an interlayer space is formed between the titanium cladding element and the lower surface of the titanium cookware body, the profile shape of the heat-conducting element is configured to be able to be accommodated in the interlayer space, the heat-conducting element is fixed to the lower surface of the titanium cookware body through the titanium cladding element, and the top surface of the heat-conducting element contacts the lower surface of the titanium cookware body, so that the present disclosure can provide an anti-stick titanium cookware having a good thermal conductivity, a uniform temperature distribution and a non-stick surface.

In more detail, in the above-mentioned technical solution of the present disclosure, the heat-conducting element can be fixed through the titanium cladding element, so that the heat-conducting element is not easily separated from the lower surface of the titanium cookware body due to thermal expansion and contraction deformation.

In addition, the anti-stick layer is a titanium oxide layer formed on the upper surface of the titanium cookware body through thermal oxidation means, so that the anti-stick layer is non-toxic, and it is not easy to wear for a long time, and it is also not easy to peel off.

Furthermore, the heat-conducting element of the present disclosure can be a supporting material layer made of iron, steel, or stainless steel in combination with two sides of the heat-conducting material layer, and the outer peripheral edge of the supporting material layer is sealed through the annular side portion, so that when the temperature of the heat-conducting material layer exceeds the melting point, the heat-conducting material layer and the supporting material layer of the heat-conducting element are combined into an assembled structure through the limitation of the two supporting material layers and the annular side portion limit, so that the shape of the heat-conducting element can be maintained as a plate shape even when the temperature of the heat-conducting element is higher than the melting point of the heat-conducting material layer.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A anti-stick titanium cookware, comprising:
a first aluminum alloy layer;
two second aluminum alloy layers disposed at two opposite sides of the first aluminum alloy layer;
a titanium layer disposed at one side of one of the second aluminum alloy layers away from the first aluminum alloy layer; and
a stainless steel layer disposed at one side of another one of the second aluminum alloy layers away from the first aluminum alloy layer,
wherein a tensile strength of the first aluminum alloy layer is greater than a tensile strength of each of the second aluminum alloy layers,
wherein the anti-stick titanium cookware bends from stainless layer to the titanium layer to form an accommodating space in a concave shape.

2. The anti-stick titanium cookware according to claim 1, wherein based on 100 parts by weight of the first aluminum alloy layer, the first aluminum alloy layer includes 1 part by weight to 1.5 part by weight of manganese, 0.05 parts by weight to 0.2 parts by weight of copper, 0.5 parts by weight to 0.9 parts by weight of iron, 0.4 parts by weight to 0.8 parts by weight of silicon, 0.05 parts by weight to 0.15 parts by weight of zinc, and a remaining amount of aluminum.

3. The anti-stick titanium cookware according to claim 1, wherein, based on 100 parts by weight of each of the second aluminum alloy layers, each of the second aluminum alloy layers includes 0.01 parts by weight to 0.25 parts by weight of silicon, 0.01 parts by weight to 0.05 parts by weight of copper, 0.01 parts by weight to 0.05 parts by weight of magnesium, 0.01 parts by weight to 0.05 parts by weight of zinc, 0.01 parts by weight to 0.05 parts by weight of manganese, 0.01 parts by weight to 0.03 parts by weight of titanium, 0.01 parts by weight to 0.05 parts by weight of vanadium, 0.01 parts by weight to 0.4 parts by weight of iron, and a remaining amount of aluminum.

4. The anti-stick titanium cookware according to claim 1, wherein, based on 100 parts by weight of the stainless steel layer, the stainless steel layer includes 0.01 parts by weight to 0.12 parts by weight of carbon, 0.01 parts by weight to 1 part by weight of manganese, 0.01 parts by weight to 0.04 parts by weight of phosphorus, 0.01 parts by weight to 0.03 parts by weight of sulfur, 0.01 parts by weight to 1 part by weight of silicon, 16 parts by weight to 18 parts by weight of chromium, and a remaining amount of iron.

5. The anti-stick titanium cookware according to claim 1, wherein the tensile strength of the first aluminum alloy layer is between 110 Mpa and 120 Mpa, and the tensile strength of each of the second aluminum alloy layers is between 70 Mpa and 80 Mpa.

6. The anti-stick titanium cookware according to claim 1, wherein a thickness of the first aluminum alloy layer is between 0.5 mm and 0.7 mm, and a thickness of each of the second aluminum alloy layers is between 0.5 mm and 0.7 mm.

7. The anti-stick titanium cookware according to claim 1, wherein a thickness of the titanium layer is between 0.4 mm and 0.5 mm, and a thickness of the stainless layer is between 0.4 mm and 0.5 mm.

8. The anti-stick titanium cookware according to claim 1, wherein the anti-stick titanium cookware is in a five-layered structure.
